(19) United States
(12) Patent Application Publication
(10) Pub. No.: US 2003/0161513 A1
(43) Pub. Date: Aug. 28, 2003

(54) Computerized schemes for detecting and/or diagnosing lesions on ultrasound images using analysis of lesion shadows

(75) Inventors: Karen Drukker, Chicago, IL (US); Maryellen L. Giger, Elmhurst, IL (US)

Correspondence Address: OBLON, SPIVAK, MCCLELLAND, MAIER & NEUSTADT, P.C., 1940 DUKE STREET, ALEXANDRIA, VA, 22314, US

(73) Assignee: The University of Chicago, Chicago, IL

(21) Appl. No.: 10/079,820

(22) Filed: Feb. 22, 2002

(51) Int. Cl. G06K 9/00

(52) U.S. Cl. 382/128

(57) ABSTRACT

Computerized detection and diagnostic schemes for sonographic images combine the benefits of computerized machine detection with the acquisition of non-radiographic medical images of special use for the screening of high risk, young patients who do not want the effects of ionizing characteristic of mammography. The lesion schemes employ computer-assisted interpretation of medical sonographic images, and output potential lesion sites and/or diagnosis of those lesions. More specifically, an embodiment of the computerized detection scheme involves convoluting a sonographic image with a mask of a given ROI (region of interest) size, and calculating a skewness value for each mask location, and assembling the calculated skewness values to form a skewness image. Thresholds are applied to pixels of the skewness image to determine potential shadows. (Ultrasound images show characteristic posterior acoustic behavior for different lesion types: Posterior acoustic shadowing is often observed for malignant lesions and for some benign solid masses, while posterior acoustic enhancement is often seen for cysts.) An embodiment of the diagnostic scheme (classifying a detected lesion as malignant or benign, for example) involves calculating the skewness of a shadow of a detected lesion, and comparing the calculated skewness to a threshold to arrive at a diagnosis. The detection and diagnostic schemes may also involve merging skewness values with other values determined in accordance with other analytic features, to arrive more comprehensive detection and diagnoses. The schemes are computationally efficient, allowing their use in real-time sonography.

The present invention was made in part with U.S. Government support under grant number CA89452 and CA09649 from the USPHS, and U.S. Army Medical Research and Materiel Command grant number 97-2445. The U.S. Government may have certain rights to this invention.

### BACKGROUND OF THE INVENTION

1. Field of the Invention

The invention relates generally to the field of computerized, automated assessment of medical images, and more particularly to methods, systems, and computer program products for computer-aided detection and computer-aided diagnosis of lesions in medical sonographic (ultrasound) images.

The present invention also generally relates to computerized techniques for automated analysis of digital images, for example, as disclosed in one or more of U.S. Pat. Nos. 4,839,807; 4,841,555; 4,851,984; 4,875,165; 4,907,156; 4,918,534; 5,072,384; 5,133,020; 5,150,292; 5,224,177; 5,289,374; 5,319,549; 5,343,390; 5,359,513; 5,452,367; 5,463,548; 5,491,627; 5,537,485; 5,598,481; 5,622,171; 5,638,458; 5,657,362; 5,666,434; 5,673,332; 5,668,888; 5,732,697; 5,740,268; 5,790,690; 5,832,103; 5,873,824; 5,881,124; 5,931,780; 5,974,165; 5,982,915; 5,984,870; 5,987,345; 6,011,862; 6,058,322; 6,067,373; 6,075,878; 6,078,680; 6,088,473; 6,112,112; 6,138,045; 6,141,437; 6,185,320; 6,205,348; 6,240,201; 6,282,305; 6,282,307; 6,317,617;

as well as U.S. patent application Ser. Nos. 08/173,935; 08/398,307 (PCT Publication WO 96/27846); Ser. Nos. 08/536,149; 08/900,189; 09/027,468; 09/141,535; 09/471,088; 09/692,218; 09/716,335; 09/759,333; 09/760,854; 09/773,636; 09/816,217; 09/830,562; 09/818,831; 09/842,860; 09/860,574; Nos. 60/160,790; 60/176,304; 60/329,322; Ser. Nos. 09/990,311; 09/990,310; Nos. 60/332,005; and 60/331,995;

as well as co-pending U.S. patent applications (listed by attorney docket number) 215752US-730-730-20, 216439US-730-730-20, and 218013US-730-730-20;

as well as PCT patent applications PCT/US98/15165; PCT/US98/24933; PCT/US99/03287; PCT/US00/41299; PCT/US01/00680; PCT/US01/01478 and PCT/US01/01479,

all of which documents are incorporated herein by reference.

The present invention includes use of various technologies referenced and described in the above-noted U.S. Patents and Applications, as well as described in the non-patent references identified in the following List of Non-Patent References by the author(s) and year of publication and cross referenced throughout the specification by reference to the respective number, in parentheses, of the reference:

### LIST OF NON-PATENT REFERENCES

1. Warner E, Plewes D B, Shumak R S, Catzavelos G C, Di˜Prospero L S, Yaffe M J, Ramsay G E, Chart P L, Cole D E C, Taylor G A, Cutrara M, Samuels T H, Murphy J P, Murphy J M, and Narod S A. “Comparison of breast magnetic resonance imaging, mammography, and ultrasound for surveillance of women at high risk of hereditary breast cancer.” J Clin Oncol, 19:3524-3531, 2001

2. Weber W N, Sickles E A, Callen P W, and Filly R A. “Nonpalpable breast lesion localization: limited efficacy of sonography.” Radiology, 155:783-784, 1985.

3. Hilton S V, Leopold G R, Olson L K, and Wilson S A. “Real-time breast sonography: application in 300 consecutive patients.” Am J Roentgenol, 147:479-486, 1986.

4. Sickles S A, Filly R A, and Callen P W. “Benign breast lesions: ultrasound detection and diagnosis.” Radiology, 151:467-470, 1984.

5. Velez N, Earnest D E, and Staren E D. “Diagnostic and interventional ultrasound for breast disease.” Am J Surg, 280:284-287, 2000.

6. Stavros A T, Thickman D, Rapp C L, Dennis M A, Parker S H, and Sisney G A. “Solid breast nodules: use of sonography to distinguish between benign and malignant lesions.” Radiology, 196:123-134, 1995.

7. Rahbar G, Sie A C, Hansen G C, Prince J S, Melany M L, Reynolds H E, Jackson V P, Sayre J W, and Bassett L W. “Benign versus malignant solid breast masses: Us differentiation.” Radiology, 213:889-894, 1999.

8. Chen D-R, Chang R-F, and Huang Y-L. “Computer-aided diagnosis applied to us of solid breast nodules by using neural networks.” Radiology, 213:407-412, 1999.

9. Buchberger W, DeKoekkoek-Doll P, Springer P, Obrist P, and Dunser M. “Incidental findings on sonography of the breast: clinical significance and diagnostic workup.” Am J Roentgenol, 173:921-927, 1999.

10. Berg W A and Gilbreath P L. “Multicentric and multifocal cancer: whole breast us in preoperative evaluation.” Radiology, 214:59-66, 2000.

11. Zonderland H M, Coerkamp E G, Hermans J, van˜de Vijver˜M J, and van Voorthuisen˜A E. “Diagnosis of breast cancer: contribution of us as an adjunct to mammography.” Radiology, 213:413-422, 1999.

12. Moon W K, Im˜J-G, Koh Y H, Noh D-Y, and Park I A. “US of mammographically detected clustered microcalcifications.” Radiology, 217:849-854, 2000.

13. Bassett L W, Israel M, Gold R H, and Ysrael C. “Usefulness of mammography and sonography in women $<$ 35 yrs old.” Radiolography, 180:831, 1991.

14. Kolb T M, Lichy J, and Newhouse J H. “Occult cancer in women with dense breasts: detection with screening us—diagnostic yield and tumor characteristics.” Radiology, 207:191-199, 1998.

15. Giger M L, Al-Hallaq H, Huo Z, Moran C, Wolverton D E, Chan C W, and Zhong W. “Computerized analysis of lesions in us images of the breast.” Acad Radiol, 6:665-674, 1999.

16. Garra B S, Krasner B H, Horii S C, Ascher S, Mun S K, and Zeman R K. “Improving the distinction between benign and malignant breast lesions: the value of sonographic texture analysis.” Ultrason Imaging, 15:267-285, 1993.

17. Chen D R, Chang R F, and Huang Y L. “Computer-aided diagnosis applied to us of solid breast nodules by using neural networks.” Radiology, 213:407-412, 1999.

18. Golub R M, Parsons R E, Sigel B, and et al. “Differentiation of breast tumors by ultrasonic tissue characterization.” J Ultrasound Med, 12:601-608, 1993.

19. Sahiner B, LeCarpentier G L, Chan H P, and et al. “Computerized characterization of breast masses using three-dimensional ultrasound images.” Proceedings of the SPIE, vol. 3338, pages 301-312, 1998.

20. Horsch K, Giger M L, Venta L A, and Vyborny C J. “Computerized diagnosis of breast lesions on ultrasound.” Med Phys, 2000. in press.

21. Tohno E, Cosgrove D O, and Sloane J P. Ultrasound Diagnosis of Breast Disease. Churchill Livingstone, Edinburgh, Scotland, 1994.

The contents of each of these references, including patents and patent applications, are incorporated herein by reference. The techniques disclosed in the patents, patent applications and other references can be utilized as part of the present invention.

2. Discussion of the Background

Breast cancer is the leading cause of death for women in developed countries. Detection of breast cancer in an early stage increases success of treatment dramatically, and hence screening for breast cancer of women over 40 years of age is generally recommended.

Current methods for detecting and diagnosing breast cancer include mammography, sonography (also referred to as ultrasound), and magnetic resonance imaging (MRI). Mammography is the standard method used for periodic screening of women over 40 years of age. MRI has recently gained interest as a breast cancer screening tool (Reference 1), but has not been used widely. The present invention is especially concerned with computer aided diagnosis to facilitate the use of sonography as a screening method for women at high risk for breast cancer.

In the mid 1980s, sonography gained in interest as an imaging tool for breast cancer, but at that time the results were disappointing, both for localization (Reference 2) and screening (Reference 3). Sonography is currently the method of choice to distinguish simple cysts of the breast from solid lesions (Reference 4), while most radiologists still feel uncomfortable relying on ultrasound to differentiate solid masses. The use, however, of diagnostic and interventional sonography for breast cancer has grown rapidly over the last years (Reference 5). Recently, several groups have shown that sonography can be used for classification of solid benign and malignant masses (References 6 and 7). Others showed that the use of computer classification schemes for the distinction between benign and malignant masses helped inexperienced operators avoid misdiagnosis (Reference 8).

The merits of sonography as an adjunct to mammography have been researched by several groups. Sonography is especially helpful for detection of otherwise occult malignancies in (young) women with dense breasts (Reference 9), and for preoperative evaluation (particularly when breast conservation is considered) (Reference 10). Another study showed that the use of sonography as an adjunct to mammography results in a relevant increase in the diagnostic accuracy (Reference 11). Ultrasound was also shown to be helpful in the detection of masses associated with mammographically detected microcalcifications (Reference 12).

The use of sonography by itself as a screening tool, on the other hand, is still controversial. Mammograms of younger women are often hard to interpret, however, and sonography was shown to be more effective for women younger than 35 (Reference 13), and to be able to achieve similar general effectiveness as mammography. A study of the effectiveness of ultrasound as a screening tool for women with dense breasts, examined more than 11,000 consecutive patients (Reference 14). All women with dense breasts and normal mammographic and physical examinations (over 3,000) were selected for sonography. Use of ultrasound increased overall cancer detection by 17%. It was shown that ultrasound is able to depict small, early-stage, otherwise occult malignancies, similar in size and stage as those detected by mammography, and smaller and lower in stage than palpable cancers in dense breasts.

This illustrates that sonography has potential as a screening tool. Added benefits are that sonography equipment is relatively cheap and portable, provides real-time imaging, and does not involve ionizing radiation, which is of great importance to younger women. Young women who are at high risk for breast cancer, could potentially benefit greatly from the use of sonography for screening purposes.

Sonography, however, is much more operator dependent than mammography, and requires thorough operator training. The inventors have recognized that use of computer tools should diminish operator dependency and aid in making correct diagnoses. Thus, the present invention provides a computer aided diagnosis (CAD) method to improve lesion detection by ultrasound. Computer-aided diagnosis (CAD) methods on breast ultrasound are being explored by various researchers (References 15, 16 17, 18, 19 and 20). Whereas to date many have concentrated on distinguishing different lesion types (given a known lesion location), there remains a need to provide automated initial lesion detection.

### SUMMARY OF THE INVENTION

Accordingly, an object of this invention is to provide a scheme that detects lesions on medical ultrasound images.

Another object of this invention is to provide a scheme that detects lesion shadows on medical ultrasound images.

Another object of the invention is to provide an automated scheme that detects and/or diagnoses or otherwise classifies both cancerous and/or non-cancerous lesions on ultrasound images of the breast for screening of asymptomatic patients.

Another object of the invention is to provide a scheme that employs computer assisted interpretation of medical ultrasound images and outputs to the radiologist/physician output from the computer analysis of the medical images.

These and other objects are achieved according to the invention by providing a new automated scheme that detects and/or diagnoses lesions on medical sonographic images using skew analysis of the sonographic images.

A preferred embodiment of the present invention analyzes a sonographic image and outputs indications of potential lesion sites and/or lesion shadows. More specifically, an embodiment of the inventive computerized technique includes convoluting a sonographic image with a mask of a given ROI (region of interest) size and shape, and calculating a skewness for each mask location to contribute to an estimate of likelihood that the pixel at that location is part of a potential lesion site or shadow.

A specific embodiment accumulates skewness values to form a skewness image. Thresholds are applied to pixels in the skewness image in order to determine potential areas of shadowing, the center of an area of interest constituting a detection point (a shadow that subsequently indicates a potential lesion).

Further, inventive diagnostic methods are provided. The skewness of an area determined to be a shadow contributes to an estimate of the likelihood of malignancy of the area. In a specific embodiment, the skewness values, possibly with other analytic features with which the skewness values are merged, are compared to a threshold or are otherwise analyzed in order to diagnose the corresponding lesion as being malignant or benign or to otherwise classify the lesion.

According to other aspects of the present invention, there are provided a novel system implementing the methods of this invention, and novel computer program products that upon execution cause the computer system to perform the method of the invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, in which like reference numerals refer to identical or corresponding parts throughout the several views, and in which:

FIG. 1(a) shows an exemplary method for a detecting and indicating lesions and/or lesion shadows on medical sonographic images, the method involving detecting shadows by calculating skewness values for the sonographic image to assemble a skewness image and comparing the skewness image pixels to a threshold to isolate the lesion shadow(s).

FIG. 1(b) shows another exemplary method of detecting and indicating lesions and/or lesion shadows on medical sonographic images, the method involving detecting shadows by merging calculated skewness value calculations with calculated pixel values of other analytic features, so as to assemble a merged image whose pixels are compared to a threshold so as to isolate the lesion shadow(s).

FIG. 1(c) shows an exemplary method of diagnosing a lesion as being either malignant or benign, based on comparing a calculated skewness value of the lesion's shadow to a threshold.

FIG. 1(d) shows an alternative exemplary method of diagnosing a lesion as being either malignant or benign, based on combining a calculated skewness value of the lesion's shadow with other analytic features (such as shape analysis, margin gradient analysis) to arrive at a diagnosis.

FIGS. 2(a) through 2(d) show an example of shadow detection: FIG. 2(a) shows an original sonographic image, the part used for analysis and the size of the ROI (region of interest) are marked as dotted lines, FIG. 2(b) shows a skewness image, FIG. 2(c) shows detection of a shadow, and FIG. 2(d) shows detection plus a radiologist?s hand-drawn contour. The ROI (region of interest) width is 5 millimeters and the height is 15 millimeters.

FIGS. 3(a) through 3(d) show examples of shadow detections with an ROI size of 5 by 15 mm (width by height) and a skewness threshold of 2?s. In each figure, the upper left pane shows the original image, the upper right pane shows the detection points and ROI within the image, the lower left pane shows the gray value histogram of the selected ROI, and the lower right pane shows the image with ‘detection arrows’ generated according to the present invention, and a radiologist?s hand-drawn outlines. The depicted histograms are for illustration purposes only; for calculation of the skewness, a bin width equal to one is used. FIG. 3(a) shows the process for a benign solid lesion, dual edge shadows, both detected; FIG. 3(b) for a cyst, one edge shadow; FIG. 3(c) for a malignant lesion with substantial posterior shadowing; and FIG. 3(d) for a cyst, vague but extensive shadow region leading to false-positive detection. A histogram for true-positive detection is shown.

FIGS. 4(a) through 4(d) show FROC (Free Response receiver Operating Characteristic) curves for shadow detection given a fixed ROI size of 5 by 15 mm. The variable used to sweep the curve is the value for thresholding the skewness image (in standard deviations of skewness image values). FIG. 4(a) shows FROC curves for Cysts only, FIG. 4(b) for benign solid masses only, FIG. 4(c) for malignant solids only, and FIG. 4(d) for the entire database.

FIGS. 5(a) and 5(b) show the performance in terms of true-positive fraction by case, for different ROI sizes at a false-positive (FP) occurrence of 0.25 FP/image: FIG. 5(a) shows performance for the entire database, and FIG. 5(b) for malignant lesions only.

### DETAILED DESCRIPTION OF THE PREFERRED EMBODIMENTS

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

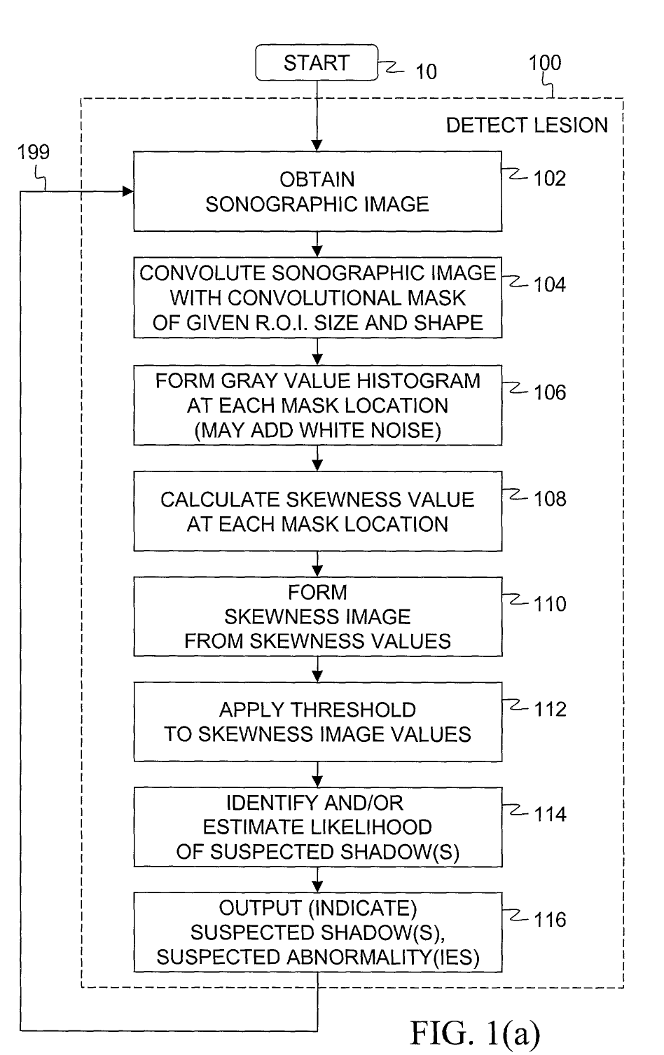

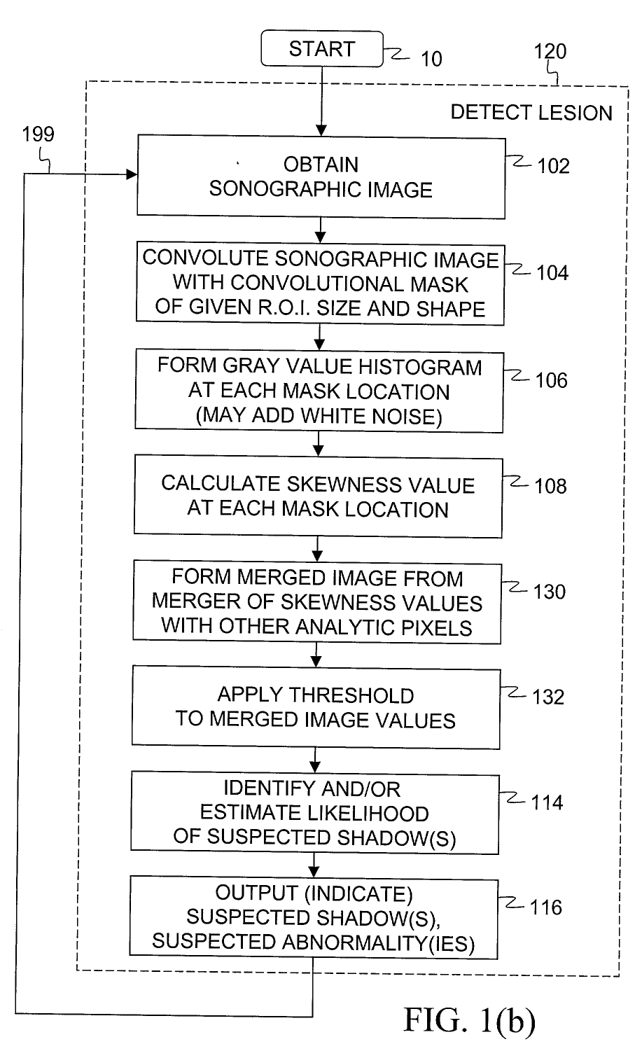

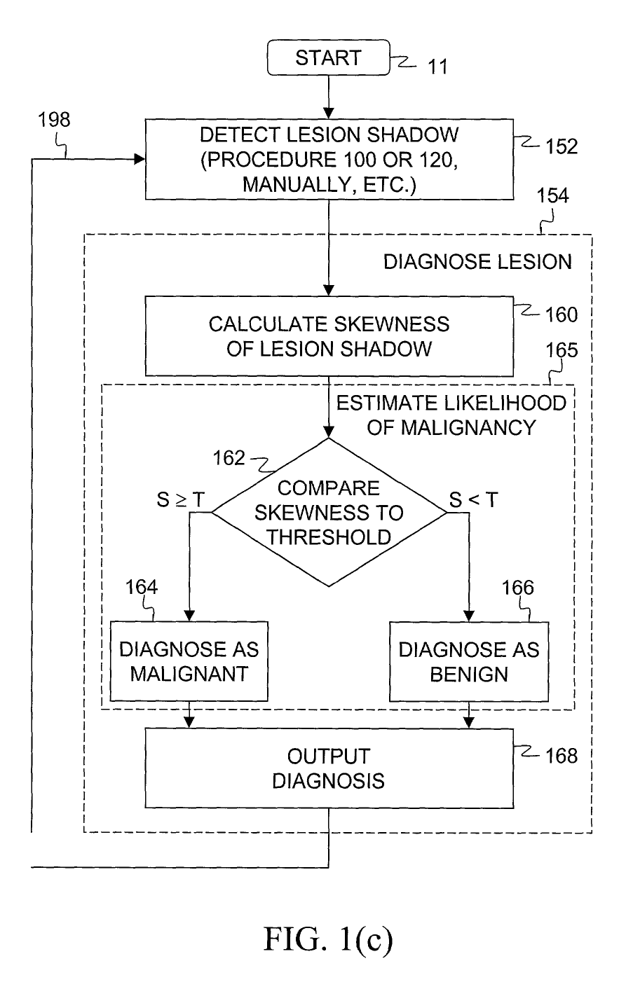

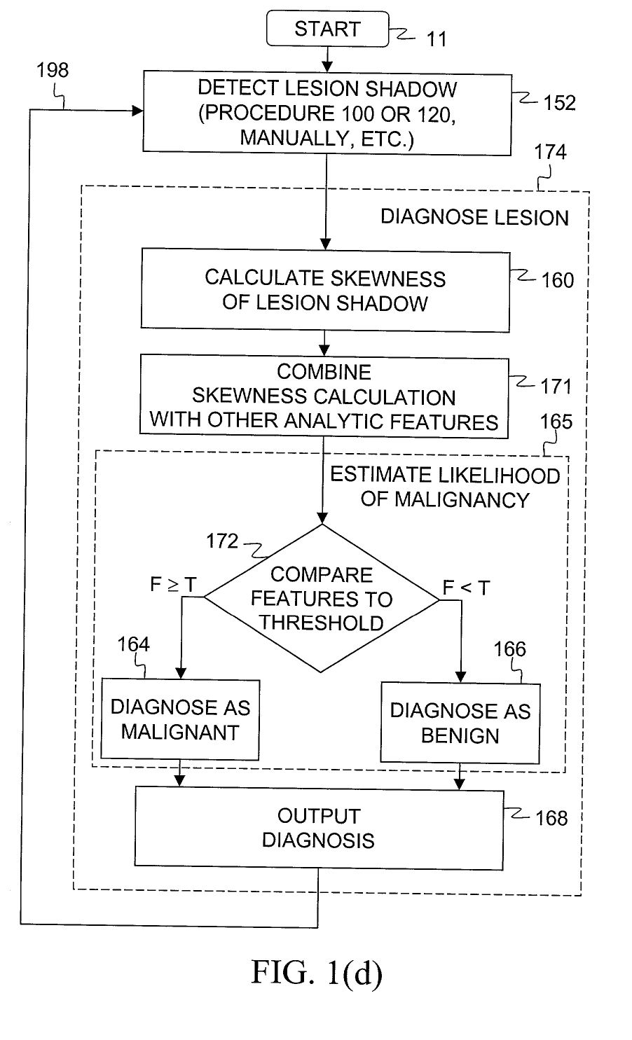

FIG. 1 is a block diagram of an exemplary lesion detection method 100 that takes as input a sonographic image, preferably in digital form, and outputs shadow regions and/or potential lesion sites deduced from the shadow regions. Processing begins at point 10.

Block 102 illustrates the input of a sonographic image, preferably in digital form, the sonographic image being obtained by conventional techniques. If the initial sonographic image is not in digital form, block 102 is understood to include the conversion of the initial sonographic image to a digital format suitable for subsequent processing.

Block 104 illustrates the convolution of the sonographic image in accordance with a mask whose size and shape are determined in accordance with a given ROI (region of interest).

Block 106 illustrates a step of forming a gray value histogram at each location of the convolutional mask. The gray value histogram is used in the subsequent step 108 of calculating skewness values.

Block 106 also illustrates the optional addition of white noise to a the histogram of each sonographic region, to prevent occurrence of regions with zero variation in pixel value. Such zero-variation regions would otherwise cause undesirable computational problems in certain computational algorithms: If the region had zero variation in pixel value, then the standard deviation used in the subsequent skewness calculation (block 108) would be zero, and the equation for skewness would involve division by zero, and the direction of skewness would remain unknown. Details of how white noise may be added to the histogram, are described with reference to the example presented below.

Block 108 illustrates the calculation of a skewness value at each location of the convolution mask. Details of a particular exemplary method of skewness calculation are provided with reference to the example presented below.

Block 110 illustrates formation of a skewness image by assembling the calculated skewness values.

Block 112 illustrates application of predetermined thresholds to pixels of the skewness image so as to permit identification of suspect shadows.

Block 114 illustrates the identification (determination or localization) of suspected area(s) of shadow in the sonographic image. In a particular embodiment, this identification is a pixel-by-pixel decision of whether or not a particular pixel is part of a shadow or related lesion. More broadly, step 114 illustrates a step of estimating a likelihood (not a binary decision) that a particular pixel or set of pixels constitutes part of a shadow or lesion. In a preferred embodiment, the center of an area of interest may be defined as a detection point constituting a shadow candidate.

Finally, block 116 illustrates the output of an emphasis symbol, such as one or more arrows or outlines or shading or other indicators, in relation to suspected shadow(s) or corresponding lesion(s). Such emphasis symbols indicate one or more suspected abnormalities (or a calculated likelihood that a given pixel or set of pixels constitutes part of a shadow or lesion).

Optionally, control passes along path 199 back to block 102 so that the blocks of lesion detection method 100 may form a loop. This loop characterizes employment of real-time sonography to detect and/or diagnose a series of plural sonographic images.

FIG. 1(b) shows an alternative exemplary method of detecting a lesion, based on combining a calculated skewness value of the lesion's shadow with other analytic features (such as shape analysis, margin gradient analysis, and so forth) on a pixel-by-pixel basis to arrive at a detection. Rather than basing a detection using a single analytic feature (such as skewness, as in the example of FIG. 1(a)), the method of FIG. 1(b) uses a merged plurality of analytic features, one of which is skewness, to arrive at a detection. The detection method of FIG. 1(b) is based on the following observations, the following discussion purposely omitting any unnecessary discussion that would duplicate that already presented for FIG. 1(a).

In addition to determining the skewness feature in the skewness value calculation step 108, other analytic features are calculated at the pixel locations. The skewness values and the other analytic features are merged to form pixels of a merged image (step 130 in FIG. 1(b)). Artificial neural networks, analytic classifiers, rule-based methods, and other classification approaches known to those skilled in the art can be applied for this purpose. The output from the neural network or other classifier is used in making a decision on detection: for example, the merged features are compared with a threshold value (step 132), and a result of the comparison for a given pixel or region constitutes an estimate of the likelihood that the pixel or region actually represents an abnormality (determined in step 114). A result of the determination is output in step 116.

Examples of analytic features other than skewness values are discussed below, with reference to FIG. 1(d).

Either of lesion detection methods 100 and 120 (FIGS. 1(a) and 1(b), respectively) can be used as a preliminary step in lesion diagnostic methods. Such diagnostic methods automatically classify the detected lesions, for example, as malignant or benign. Exemplary diagnostic methods are illustrated in FIGS. 1(c) and 1(d).

Referring now to FIG. 1(c), a first diagnostic method begins at element 11.

Block 152 illustrates the detection of a lesion shadow that indicates the presence of a potential or suspected abnormality. Lesion shadow detection step 152 may be performed automatically, using the lesion detection method 100 of FIG. 1(a) or other automated lesion detection method that may be developed. Alternatively, a human operator may manually perform lesion shadow detection step 152. For example, the operator may use a mouse (or other suitable image selection tool and related conventional software) to designate a region of a sonographic image or skewness image that the operator believes may be a shadow caused by an abnormal lesion. Based on the lesion shadow that was either an automatically detected or manually designated in step 152, a lesion diagnostic method 154 is begun.

Diagnostic method 154 begins with a step 160 of calculating the skewness of the lesion shadow. According to the invention, the skewness constitutes an estimate of the likelihood that the lesion in question is malignant. The skewness calculation may be implemented using the same steps as those performed at skewness calculation step 108 (FIG. 1(a)) and described with reference to the example presented in detail below.

Step 154 broadly denotes the estimation of the likelihood that a lesion possesses some characteristic feature. In particular, step 154 may broadly denote the estimation of the likelihood that a lesion is malignant, or an estimation of the stage of a cancerous lesion.

A more specific exemplary embodiment of likelihood estimation step 154 involves a binary decision of whether the lesion is malignant or benign. That specific embodiment includes a decision block 162 followed by two diagnosis blocks 164, 166.

Step 162 involves comparing the calculated skewness value (from step 160) to a threshold value. The threshold used in step 162 value may be determined in advance, using a library of sonograms of lesions with known classifications (malignant versus benign). Based on the principle that sonogram shadows of malignant lesions have skewness distributions that are statistically greater than those of benign lesions, the threshold is chosen to be between the distribution of malignant-lesion skewness values and the distribution of benign-lesion skewness values. Setting the threshold higher reduces the false positive rate, and setting the threshold lower reduces the false negative rate.

Referring again to FIG. 1(c), if the skewness value of the shadow under consideration is greater than the threshold, control passes to block 164, which indicates the processor's conclusion that the shadow is caused by a malignant lesion. On the other hand, if the skewness value of the shadow under consideration is less than the threshold, control passes to block 166, which indicates that the processor's conclusion that the shadow is caused by a benign lesion.

If the skewness value exactly equals the threshold value, the illustrated embodiment assumes the processor concludes the shadow is caused by a malignant lesion; however it is readily recognized that this is a special case whose implications are arbitrary, given the statistical nature of the threshold in the first place.

Finally, step 168 indicates the output of the likelihood estimation (or diagnosis) formed in block 165 (or block 164 or 166). This output may be in the form of a textual indication of a probability that a given lesion is malignant, an estimation of the stage of cancer of a malignant lesion, or an indication of a decision of malignancy or benignity. Alternatively, the output may be a graphic (e.g., color-coded) area superimposed on the displayed sonogram or skewness image to indicate a quantitative degree of belief of malignancy, stage of cancer, or the like.

Path 198, forming a loop of the detection and diagnostic methods 152, 154, illustrates the invention's ability to repeatedly detect and diagnose one or more regions of interest, a capability useful for application in real-time sonography.

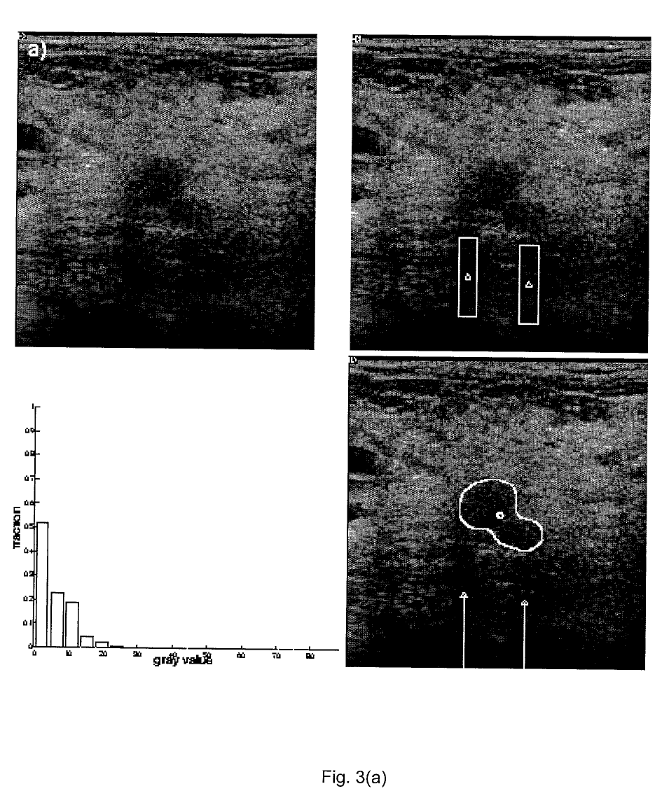

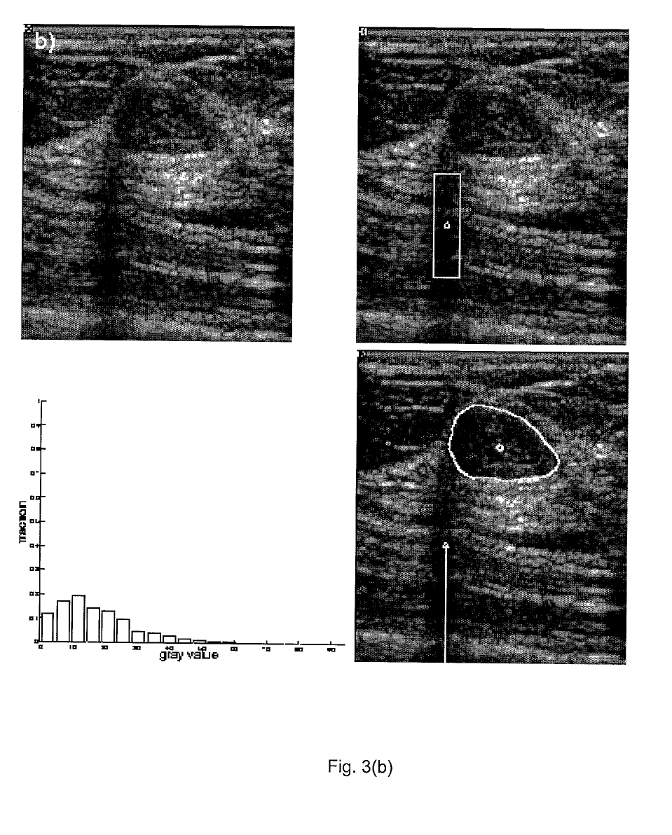

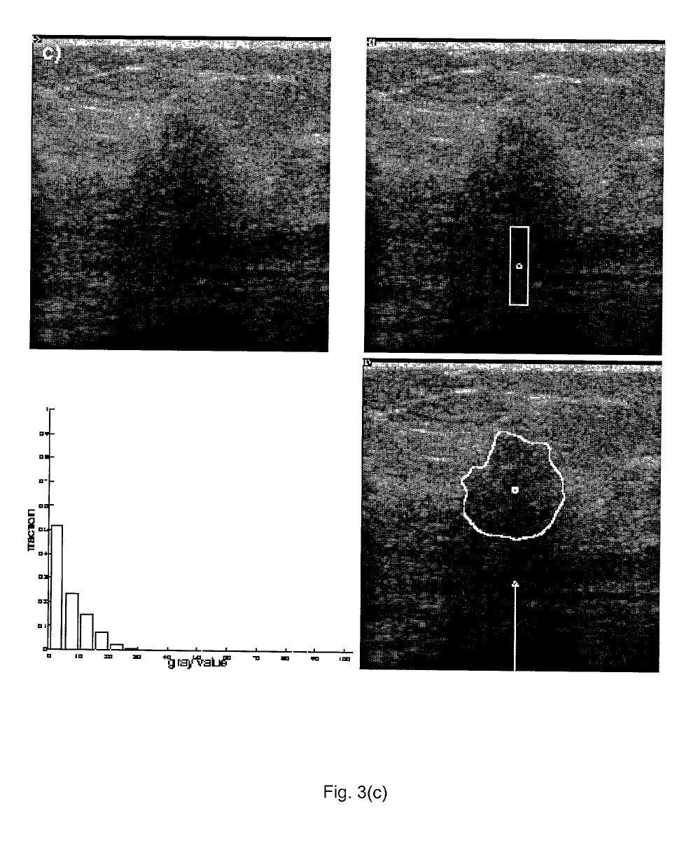

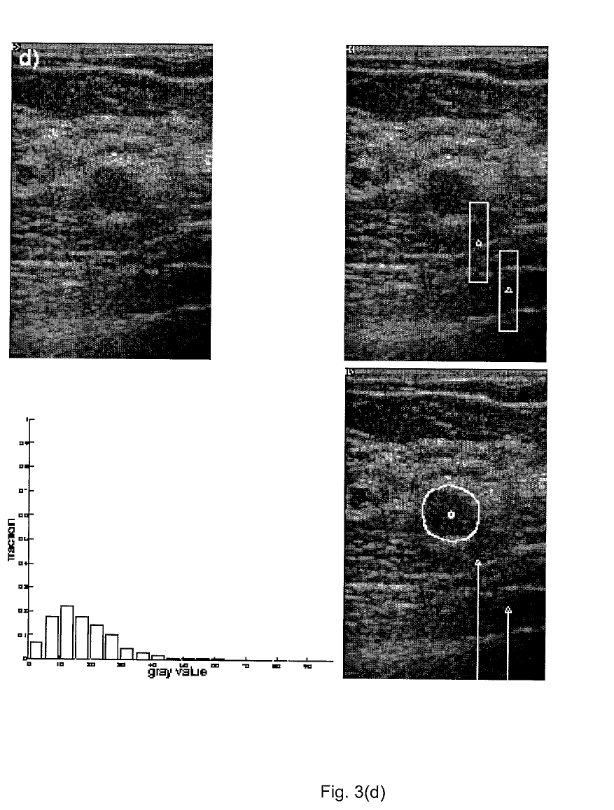

To illustrate the difference between a benign cyst and a malignant lesion, special reference is made to the examples shown in FIGS. 3(b) and 3(c). Each of FIGS. 3(a) through 3(d) show an example of shadow detections with an ROI size of 5 by 15 mm (width by height) and a skewness threshold of 2σₛ. In each figure, the upper left pane shows the original image, the upper right pane shows the detection points and ROI within the image, the lower left pane shows the gray value histogram of the selected ROI, and the lower right pane shows the image with ‘detection arrows’ generated according to the present invention, and a radiologist's hand-drawn outlines. Of particular interest to the lesion diagnosis method is a comparison of FIG. 3(b) for a cyst (one edge shadow), with FIG. 3(c) for a malignant lesion (with substantial posterior shadowing): the difference in the shadow skewness is apparent and would be distinguished by the thresholding step 162 described above.

The invention also encompasses schemes in which comparing step 162 involves more complex decision schemes, such as comparison of a shadow's skewness value to more than one threshold value, allowing a more refined decision than a binary decision between malignant and benign. For example, comparing the skewness value to two thresholds would allow diagnosis of “questionable” or “indeterminate” in addition to malignant and benign. Comparison to a greater number of thresholds allows the diagnosis to be a quantitative estimate of the likelihood of malignancy, stage of cancer, and the like rather than a binary decision.

Further, although the foregoing method is described in terms of analysis of only one shadow at a time, the invention encompasses arrangements in which plural shadows in a single sonogram can be simultaneously detected and concurrently diagnosed. Such embodiments involve parallel calculation, comparison, diagnosis and output steps 160, 162, 164, 166 for the respective plural shadows.

Thus, it is readily recognized that the scope of the present invention should not be limited to the particular embodiments described above.

FIG. 1(d) shows an exemplary method of diagnosing a lesion, based on combining a calculated skewness value of the lesion's shadow with one or more other analytic features (such as shape analysis, margin gradient analysis, and so forth) to arrive at a diagnosis (or other classification) of the lesion. Rather than basing a diagnosis on a single analytic feature (such as skewness, as in the example of FIG. 1(c)), the method of FIG. 1(d) uses a merged plurality of analytic features, one of which is skewness, to arrive at a diagnosis. The diagnosis can distinguish between malignancy and benignity, among stages of cancer, or among some other characteristics.

The diagnostic method of FIG. 1(d) is based on the following observations, the following discussion purposely omitting any unnecessary discussion that would duplicate that already presented for FIG. 1(c).

After determining the skewness feature (step 160 in FIG. 1(d)), other analytic features are merged (combined) with the skewness feature (step 171). Artificial neural networks, analytic classifiers, rule-based methods, and other classification approaches known to those skilled in the art, can be used to merge various analytic features that may be disparate in nature.

The output from the neural network or other classifier is used in making a diagnosis, likelihood estimation, prognosis, or the like. For example, the merged features may be compared with a threshold, represented by the decision in FIG. 1(d) comparison block 172, and a result of the comparison constitutes a simplified (binary decision) estimate of malignancy in classification (diagnosis) steps 164, 166). The malignancy likelihood estimation, classification, diagnosis, or prognosis, is subsequently output in block 168.

In a particularly useful application of the invention, the analysis of ultrasound images of the breast, the analytic features can be used either to distinguish between malignant and benign lesions, or to distinguish between (diagnose) types of benign lesions such as benign solid lesions (e.g., fibroadenoma), simple cysts, complex cysts, and benign cysts.

Further, the ultrasound image features can be merged with those from mammographic images of the same lesion. The output from the classifier can be used to arrive at, for example, an estimate of the likelihood that the lesion in question is malignant.

Examples of analytic features that may be combined in step 171 include:

Skewness (discussed in detail herein)

Shape (circularity and irregularity, discussed as follows)

Margin sharpness characteristics (gradient and directional analysis, discussed as follows)

Other analytic features.

Circularity and irregularity may be computed by geometry-related equations that quantify how well the lesion conforms to a circular shape, and how irregular the area is distributed over space.

Gradient and directional analysis of the gradients in the lesion and along the margin of the lesion can be performed. In one example of gradient analysis, the region is first processed by a Sobel filter in order to obtain the gradient and direction at each pixel in the ROI. Next, a gradient histogram and a weighted gradient histogram are calculated. The gradient histogram gives the frequency distribution of the pixels as a function of the direction of the maximum gradient, where each pixel is equally weighted in terms of its contribution to the histogram. The weighted gradient histogram includes the magnitude of the gradient as a weight and thus the contribution of each pixel to the histogram is weighted by its magnitude. Each of these distributions is fitted with a ninth order polynomial, and features are calculated from the fitted distributions. These features include:

average value of the gradient-weighted histogram

standard deviation of the gradient-weighted histogram

angle where peak of gradient-weighted histogram occurs

average angle of gradient-weighted histogram

full width at half maximum of the gradient-weighted histogram

Directional analysis (also referred to as radial gradient analysis) of the gradients in the lesion quantifies how uniform the lesion extends along radial lines from a center point. These features involve determining the magnitude of the gradient for a pixel in the radial direction, as shown below, with normalization.

$$RG = \frac{{\sum }_{P ∈ L}^{} cos ϕ \sqrt{{D}_{x}^{2} + {D}_{y}^{2}}}{{\sum }_{P ∈ L}^{} \sqrt{{D}_{x}^{2} + {D}_{y}^{2}}}$$

in which:

RG is a radial gradient, indexed to take on values between −1 and +1,

P is an image point,

L is the detected lesion excluding the center part,

Dx is the gradient in the x-direction,

Dy is the gradient in the y-direction, and

φ is the angle between gradient vector and connection line from center point to neighbor point.

The radial gradient analysis features include:

normalized radial gradient along the entire margin of the lesion

normalized radial gradient along only the posterior margin of the lesion

normalized radial gradient along only the lateral margins of the lesion

normalized radial gradient within a small neighborhood along the entire margin of the lesion

normalized radial gradient within a small neighborhood along only the posterior margin of the lesion

normalized radial gradient within a small neighborhood along only the lateral margins of the lesion

In a particular investigation illustrating practical application of the present invention, a database consists of 400 consecutive ultrasound cases, and is represented by 757 images. The images were obtained with an ATL 3000 unit (widely available and known to those skilled in the art) and were captured directly from the 8-bit video signal. The number of images per case varied from one to six. The cases were collected retrospectively and all had been either biopsied or aspirated. Of the 400 cases, 124 were complex cysts (229 images), 182 were benign solid lesions (334 images), and 94 were malignant solid lesions (194 images).

As a background for understanding an application of the inventive scheme for automated detection of lesions, it is recognized that ultrasound images show characteristic posterior acoustic behavior for different lesion types. Posterior acoustic shadowing is often observed for malignant lesions and for some benign solid masses, while posterior acoustic enhancement is often seen for cysts. Less significant edge shadows are in practice observed for virtually all types of lesions.

Posterior acoustic shadows appear as very dark regions that often extend from the lesion to the bottom of the image. Shadow regions show very little variation in pixel value, while normal darker regions in the image almost always show substantial variation in pixel value due the ultrasound speckle. The ultrasound speckle is also present in regions of posterior acoustic enhancement.

In order to evaluate the pixel value distribution in a given area, a histogram of the pixel values is useful. For a shadow area, the histogram shows a distribution skewed towards ‘black’. For posterior acoustic enhancement, the histogram is skewed towards ‘white’.

As used in this specification, “skewness” characterizes the degree of asymmetry of a distribution around its mean. Computationally, the skewness of a distribution may be defined as the third central moment divided by the cube of the standard deviation, and may be calculated according to a formula:

$$s ( x , y ) = \frac{1}{N} {\sum }_{( {x}^{′} , {y}^{′} ) ∈ A}^{} \frac{{( h ( {x}^{′} , {y}^{′} ) - < h ( {x}^{′} , {y}^{′} ) > )}^{3}}{{σ}_{A}^{3}}$$

in which:

x, y, and x′, y′ denote orthogonal directional components in the skewness image and sonographic image, respectively,

A is a region of interest (ROI) centered at a location (x′, y′) in the sonographic image,

s (x, y) denotes a skewness value at location (x, y) in the skewness image, and represents a skewness of a pixel value distribution of the specified region of interest A centered at a corresponding location (x′, y′) in the sonographic image,

N denotes a number of data points in the region of interest A,

h(x′, y′) denotes a pixel value in the sonographic image at a location (x′, y′),

< >denotes arithmetic mean, and

σ_{A} denotes a standard deviation of a gray-value distribution in region of interest A.

According to a preferred embodiment, a skewness image may be obtained by convoluting an original sonographic image with a mask the size of the region of interest (ROI), and calculating the skewness for each mask location according to the above formula. Skewness values may be assigned to mask center points (x, y) to form the skewness image.

The exemplary procedure does not assign values to pixels in the skewness image closer to the edge than the full ROI size allows, thus leaving the borders of the skewness image blank. The pixel values in the skewness image are an estimate of the likelihood that a shadow is present. However, skewness values can theoretically be anywhere between +/− infinity.

Predetermined thresholds are compared to the skewness image values to determine areas of interest when the thresholds are exceeded. The skewness image may be scaled to have zero mean and unit standard deviation (σₛ equaling 1.0 after the scaling procedure), this scaling allowing the method to employ a threshold value t that is given in units of standard deviation σₛ of the calculated skewness image (excluding the undefined edge pixels). That is:

t=mσₛ

where m is chosen depending on a desired sensitivity and false-positive detection rate, and may be determined, for example, by calibration experimentation with existing sonograms and lesions of a known character. The center of an area of interest may be defined as a detection point constituting a shadow candidate that may constitute a suspected abnormality.

The inventive system conveniently may be implemented using a conventional general purpose computer or microprocessor programmed according to the teachings of the present invention, as will be apparent to those skilled in the computer art. Appropriate software can readily be prepared by programmers of ordinary skill based on the teachings of i the present disclosure, as will be apparent to those skilled in the software art.

As disclosed in cross-referenced U.S. patent application Ser. No. 09/818,831, a computer may implement the method of the present invention, wherein the computer housing houses a motherboard which contains a CPU (central processing unit), memory such as DRAM (dynamic random access memory), ROM (read-only memory), EPROM (erasable programmable read-only memory), EEPROM (electrically erasable programmable read-only memory), SRAM (static random access memory), SDRAM (synchronous dynamic random access memory), and Flash RAM (random access memory), and other optical special purpose logic devices such as ASICs (application-specific integrated circuits) or configurable logic devices such GAL (generic array logic) and reprogrammable FPGAs (field programmable gate arrays).

The computer may also include plural input devices, (e.g., keyboard and mouse), and a display card for controlling a monitor. Additionally, the computer may include a floppy disk drive; other removable media devices (e.g. compact disc, tape, and removable magneto-optical media); and a hard disk or other fixed high density media drives, connected using an appropriate device bus such as a SCSI (small computer system interface) bus, an Enhanced IDE (integrated drive electronics) bus, or an Ultra DMA (direct memory access) bus. The computer may also include a compact disc reader, a compact disc reader/writer unit, or a compact disc jukebox, which may be connected to the same device bus or to another device bus.

As stated above, the system includes at least one computer readable medium. Examples of computer readable media include compact discs, hard disks, floppy disks, tape, magneto-optical disks, PROMs (e.g., EPROM, EEPROM, Flash EPROM), DRAM, SRAM, SDRAM, etc. Stored on any one or on a combination of computer readable media, the present invention includes software for controlling both the hardware of the computer and for enabling the computer to interact with a human user. Such software may include, but is not limited to, device drivers, operating systems and user applications, such as development tools.

Such computer readable media further includes the computer program product of the present invention for performing the inventive method herein disclosed. The computer code devices of the present invention can be any interpreted or executable code mechanism, including but not limited to, scripts, interpreters, dynamic link libraries, Java classes, and complete executable programs.

Moreover, parts of the processing of the present invention may be distributed for better performance, reliability, and/or cost. For example, an outline or image may be selected on a first computer and sent to a second computer for remote diagnosis.

The invention may also be implemented by the preparation of application specific integrated circuits (ASICs) or by interconnecting an appropriate network of conventional component circuits, as will be readily apparent to those skilled in the art.

Performance of an embodiment of the inventive shadow detection method was analyzed by designating detection points located below a lesion in a vertical ROI with the width of the lesion as true-positive (TP) detections. All detection points outside of this vertical ROI are defined as false-positive (FP) detections. This analysis was performed for all images, including those without substantial acoustic shadowing and those with large artifact shadows. TABLE 1 describes the database in terms of the presence of shadowing:

TABLE 1
Description of database in terms of presence of shadowing

Percent of Images showing:

| Lesion Type | Posterior Shadow | No Substantial Shadow | Artifact |
|---|---|---|---|
| Cyst | 11.8 | 58.5 | 29.7 |
| benign solid | 21.6 | 52.7 | 25.7 |
| malignant solid | 37.6 | 42.8 | 19.6 |
| entire database | 22.7 | 51.9 | 25.7 |

In a particular exemplary application, a subsampling factor of 4 was used in the calculation of the skewness images (that is, every fourth pixel was used). The images were cropped by 2 millimeter at all edges, since often artifacts were observed close to the image edge. The region of interest (ROI) was chosen as a rectangle since the shadow structures of interest tend to have a rectangular shape. Different ROI sizes were employed. For a ROI height of 15 mm, widths of 1.25, 2.5, and 5 mm were used; for a ROI height of 10 mm, widths of 2.5 and 5 mm were investigated; and for a ROI height of 5 mm, a width of 2.5 mm was employed.

The skewness values were calculated by convoluting the ROI mask with the images, and calculating the skewness of the pixels in the ROI combined with a small number of white noise pixels. White noise is added in step 106 in order to prevent undesirable computational problems upon encountering image regions with zero variation in pixel value.

The computation problem would otherwise arise in the following manner. If the region had zero variation in pixel value, then the standard deviation would be zero and the equation for skewness would involve division by zero, and the direction of skewness would remain unknown.

The size of the white noise region may be chosen to be 10% of the ROI, and to have a mean equal to the average pixel value of the full image. For a given image, the same white noise region may be used for each convolution of the ROI mask with the image. The threshold value in the analysis of the skewness image, i.e., in the determination of areas of interest, ranged between 0.25 and 3.75 standard deviations.

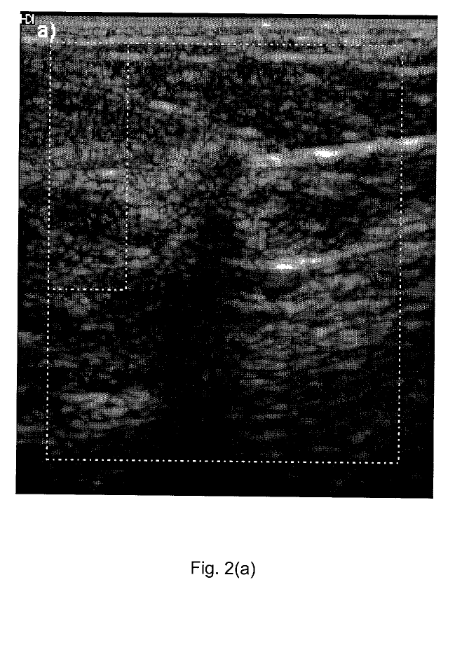

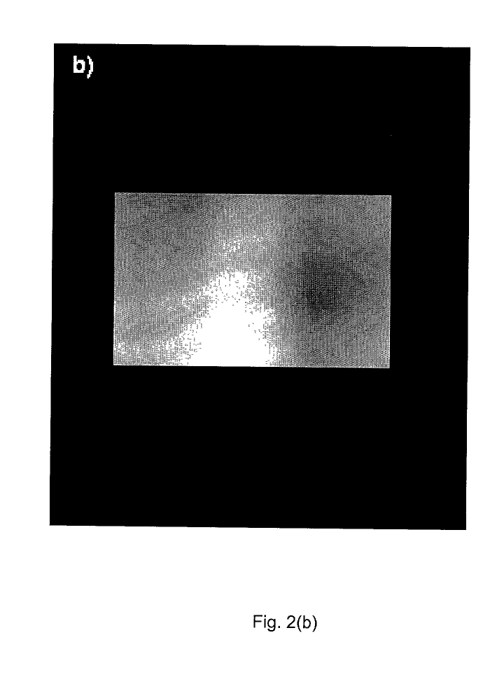

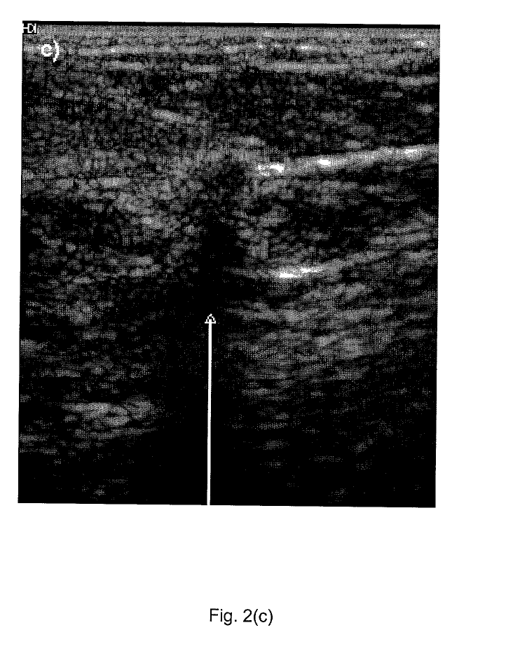

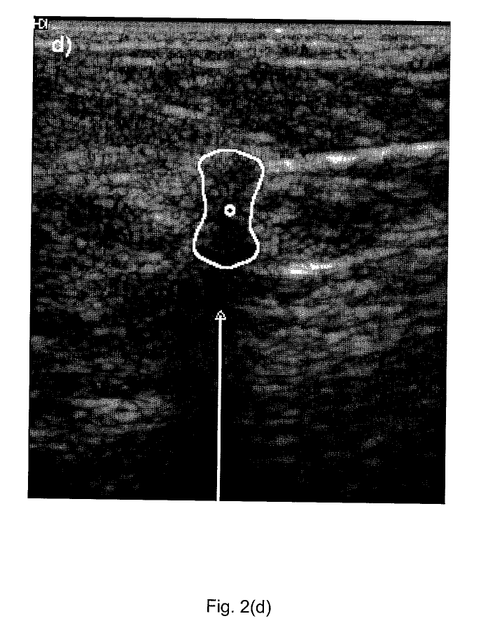

An example of the skewness filtering procedure, using an ROI of 5 (width) by 15 (height) mm, is shown in FIG. 2. The original image is shown and the analyzed region is marked as well as the used ROI mask. In FIG. 2(b), the obtained skewness image is shown, and in FIG. 2(c) the resulting output of the analysis is presented. The output format visually aids detection of lesion shadows. The distance of a detection point to the lesion is not important in this analysis.

A detection point indicates a need for further investigation up in the vertical direction, and hence vertical arrows are used in the visualization of the computer detections. FIG. 2(d) shows the radiologist's hand-drawn outline of the malignant lesion and the automatically-generated detection arrow.

Analysis of the shadowing of images is further illustrated in FIGS. 3(a) through 3(d). The gray value histograms of the ROIs and the obtained detections are shown for different lesion types. FIGS. 3(a) through 3(d) show examples of shadow detections with an ROI size of 5 by 15 mm (width by height) and a skewness threshold of 2σₛ. In each figure, the upper left pane shows the original image, the upper right pane shows the detection points and ROI within the image, the lower left pane shows the gray value histogram of the selected ROI, and the lower right pane shows the image with ‘detection arrows’ generated according to the present invention, and a radiologist's hand-drawn outlines. The depicted histograms are for illustration purposes only; for calculation of the skewness, a bin width equal to one is used. FIG. 3(a) shows the process for a benign solid lesion, dual edge shadows, both detected; FIG. 3(b) for a cyst, one edge shadow; FIG. 3(c) for a malignant lesion with substantial posterior shadowing; and FIG. 3(d) for a cyst, vague but extensive shadow region leading to false-positive detection. A histogram for true-positive detection is shown.

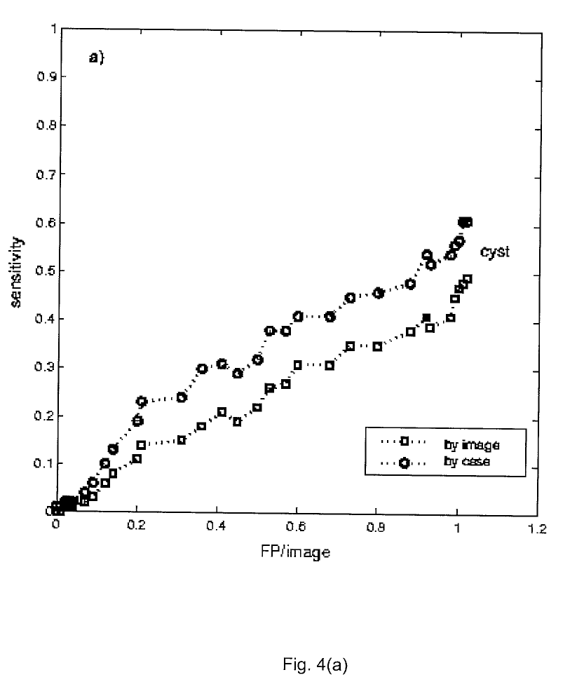

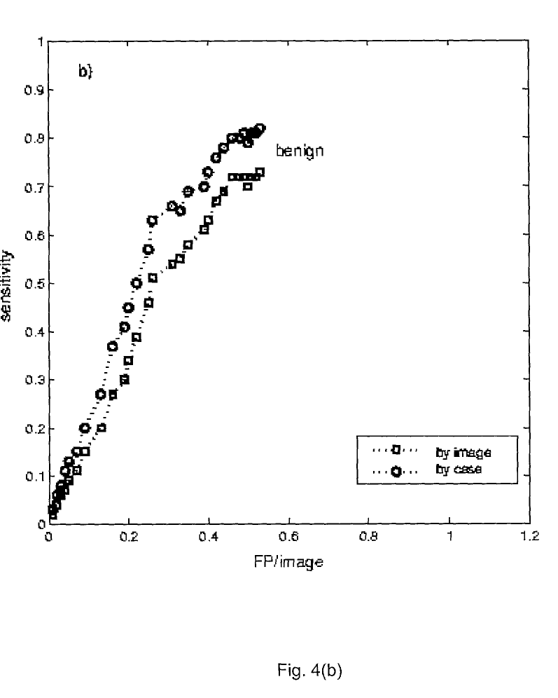

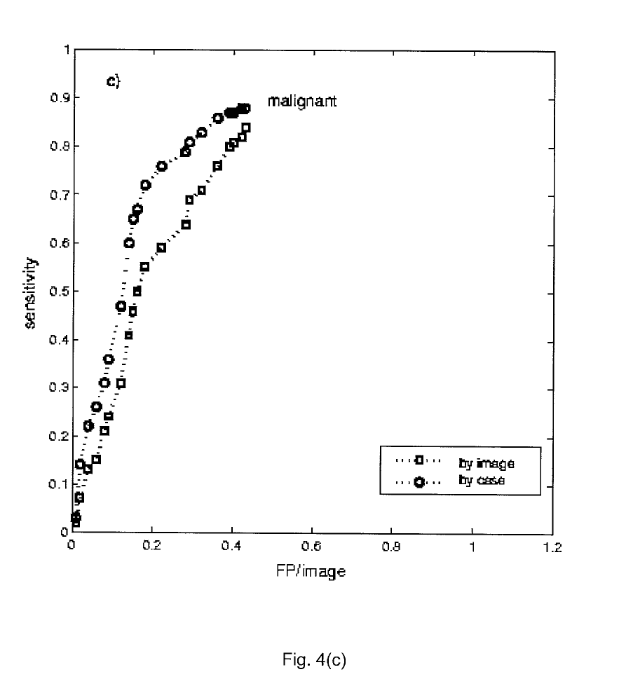

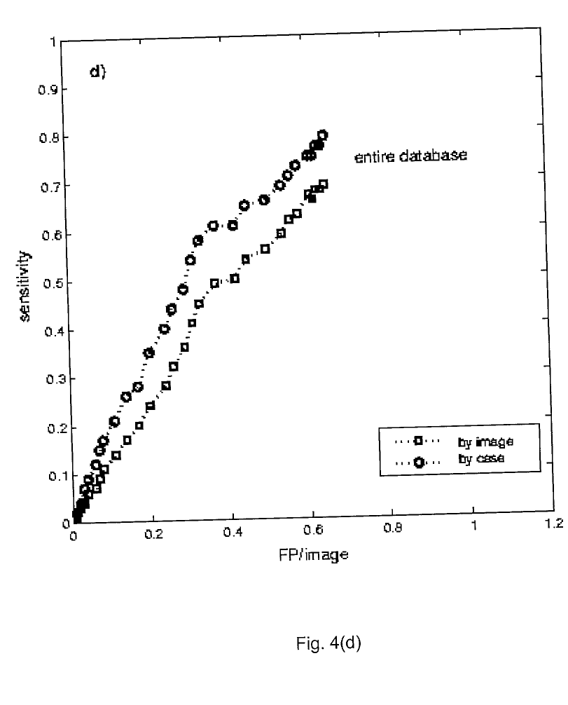

FIG. 4 shows the FROC (Free Response receiver Operating Characteristic) curves for different lesion types obtained by varying the skewness threshold value for a given ROI size of 5 by 15 mm. The FROC curves are not monotonic because increasing the threshold values often results in splitting of regions, and hence in more detection points. Cyst images show limited shadowing, and hence shadow detection results in a limited number of true-positive lesion detections. Images in the database of both benign solid lesions and malignant lesions show substantial shadowing, and hence shadow detection leads to good performance in lesion detection.

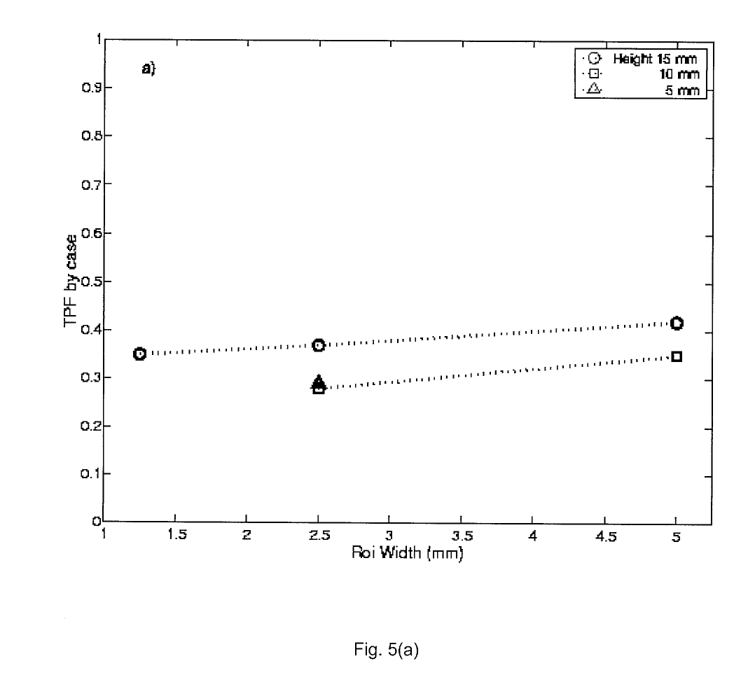

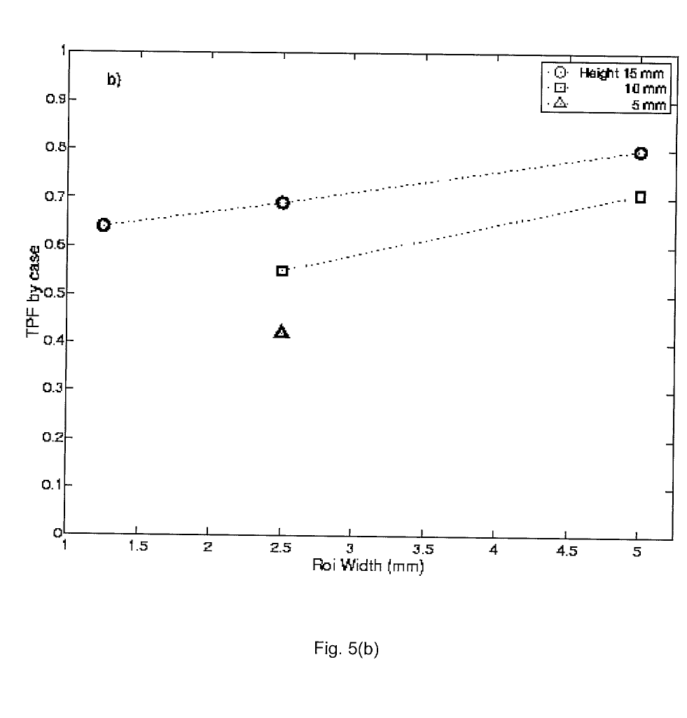

The effect of the ROI width and height on the true-positive (TP) detection rate is depicted in FIG. 5, in which TPF denotes True Positive Fraction. For a given false-positive (FP) per image level, performance is seen to improve for longer and wider ROIs. However, the image size forms a physical limitation for the maximum reasonable ROI size.

Numerous modifications and variations of the present invention are possible in light of the above teachings. For example, in addition to use of the skewness method for detection, the skewness method can also be used to characterize (or otherwise diagnose) lesions by comparing the histograms and/or skewness values of malignant and benign lesion as demonstrated in FIGS. 3(b) and 3(c). Further, although the method is described with reference to sonographic breast image data sets, the inventive computerized detection and analysis scheme can be implemented on other medical sonographic images (such as liver images) in which a computerized detection of image or lesion features is performed with respect to some disease state. Also, other ways of calculating skewness values may also be employed, without departing from the scope of the invention. Of course, the particular hardware or software implementation of the invention may be varied while still remaining within the scope of the present invention. It is therefore to be understood that within the scope of the appended claims and their equivalents, the invention may be practiced otherwise than as specifically described herein.

What is claimed as new and desired to be secured by Letters Patent of the united states is:

1. A method of detecting at least a candidate abnormality in a sonographic image, the method comprising:
calculating plural skewness values at respective plural locations in the sonographic image; and
determining an area in the sonographic image to be the candidate abnormality, based at least in part on the skewness values.

2. The method of claim 1, further comprising:
merging the skewness values with other pixel values determined in accordance with other analytic features, so as to form plural merged pixels;
forming a merged image from the plural merged pixels; and
comparing the merged values in the merged image to a threshold, so as to arrive at comparison results that are used in the candidate abnormality area determining step.

3. The method of claim 2, wherein:
the other analytic features are derived from the sonographic image.

4. The method of claim 1, further comprising:
forming a skewness image from the plural skewness values; and
comparing the skewness values in the skewness image to a threshold, so as to arrive at comparison results that are used in the candidate abnormality area determining step.

5. The method of claim 4, wherein the calculating step comprises:
convoluting the sonographic image with a mask by moving the mask over plural locations in the sonographic image; and
calculating the plural skewness values at respective locations of the mask.

6. The method of claim 5, wherein the skewness image forming step comprises:
assigning the plural skewness values to respective mask center points.

7. The method of claim 4, wherein the candidate abnormality area determining step comprises:
determining a particular skewness value to indicate part of a candidate abnormality when the particular skewness value exceeds the threshold.

8. The method of claim 7, further comprising:
calculating a standard deviation of skewness values in the skewness image; and
determining the threshold as a mathematical function of the standard deviation.

9. The method of claim 8, wherein the threshold determining step comprises:
determining the threshold as being directly proportional to a first power of the standard deviation of the skewness values in the skewness image.

10. The method of claim 1, wherein the calculating step comprises:
calculating the skewness values as a mathematical function of a standard deviation of a gray-value distribution of pixels in the sonographic image.

11. The method of claim 10, wherein the calculating step comprises calculating the skewness values according to a formula:
$$s ( x , y ) = \frac{1}{N} {\sum }_{( {x}^{′} , {y}^{′} ) ∈ A}^{} \frac{{( h ( {x}^{′} , {y}^{′} ) - < h ( {x}^{′} , {y}^{′} ) > )}^{3}}{{σ}_{A}^{3}}$$
in which:
x, y, and x′, y′ denote orthogonal directional components in the skewness image and sonographic image, respectively,
A is a region of interest (ROI) centered at a location (x′, y′) in the sonographic image,
s (x, y) denotes a skewness value at location (x, y) in the skewness image, and represents a skewness of a pixel value distribution of the specified region of interest A centered at a corresponding location (x′, y′) in the sonographic image,
N denotes a number of data points in the region of interest A,
h(x′, y′) denotes a pixel value in the sonographic image at a location (x′, y′),
< >denotes arithmetic mean, and
σ_{A} denotes a standard deviation of a gray-value distribution in region of interest A.

12. The method of claim 1, further comprising:
superimposing an emphasis symbol on the sonographic image so as to indicate the area that was determined to be the candidate abnormality.

13. The method of claim 1, further comprising:
forming a histogram of gray values of pixels in the sonographic image to form a gray value histogram; and
adding white noise to the gray value histogram to form a modified gray value histogram that is configured for use in the skewness value calculating step.

14. The method of claim 1, further comprising:
repeatedly executing the steps of claim 1 to detect the candidate abnormality based on a sequence of sonographic images in real time.

15. An automated method of diagnosing a candidate abnormality in a sonographic image, the method comprising:
determining an area of the candidate abnormality in the sonographic image using the candidate abnormality detecting method of any of claims 1, 2, 3, 4, 5, 6, 7, 8, 9, 10, 11, 12, 13, or 14;
calculating an abnormality skewness value of the area that was determined to be the candidate abnormality; and
determining a likelihood of malignancy of the candidate abnormality based at least in part on the abnormality skewness value.

16. The method of claim 15, wherein the likelihood determining step comprises:
comparing the abnormality skewness value to a threshold; and
determining the candidate abnormality to be malignant if the abnormality skewness value exceeds the threshold, and to be benign if the abnormality threshold exceeds the abnormality skewness value.

17. A system implementing the method of claim 16.

18. A computer program product storing program instructions for execution on a computer system, which when executed by the computer system, cause the computer system to perform the method recited in claim 16.

19. A system implementing the method of claim 15.

20. A computer program product storing program instructions for execution on a computer system, which when executed by the computer system, cause the computer system to perform the method recited in claim 15.

21. A method of diagnosing a designated candidate abnormality in an area of a sonographic image, the method comprising:
calculating an abnormality skewness value of the area; and
determining a likelihood of malignancy of the candidate abnormality based at least in part on the abnormality skewness value.

22. The method of claim 21, wherein the likelihood determining step comprises:
comparing the abnormality skewness value to a threshold; and
determining the candidate abnormality to be malignant if the abnormality skewness value exceeds the threshold, and to be benign if the abnormality threshold exceeds the abnormality skewness value.

23. A system implementing the method of any of claims 1, 2, 3, 4, 5, 6, 7, 8, 9, 10, 11, 12, 13, 14, 21 or 22.

24. A computer program product storing program instructions for execution on a computer system, which when executed by the computer system, cause the computer system to perform the method of any of claims 1, 2, 3, 4, 5, 6, 7, 8, 9, 10, 11, 12, 13, 14, 21 or 22.
